(19) United States
(12) Patent Application Publication
(10) Pub. No.: US 2017/0257610 A1
(43) Pub. Date: Sep. 7, 2017

(54) DEVICE AND METHOD FOR ORCHESTRATING DISPLAY SURFACES, PROJECTION DEVICES, AND 2D AND 3D SPATIAL INTERACTION DEVICES FOR CREATING INTERACTIVE ENVIRONMENTS

(71) Applicant: INGENUITY I/O, RAMONVILLE-SAINT-AGNE (FR)

(72) Inventors: STÉPHANE VALES, TOULOUSE (FR); VINCENT PEYRUQUÉOU, AUZEVILLE TOLOSANE (FR); ALEXANDRE LEMORT, TOULOUSE (FR)

(21) Appl. No.: 15/511,238

(22) PCT Filed: Sep. 15, 2015
(86) PCT No.: PCT/FR2015/052469

§ 371 Date: Mar. 15, 2017

(30) Foreign Application Priority Data
Sep. 16, 2014 (FR) 1458702

(51) Int. Cl. H04N 9/31; G06T 19/00; G09G 3/00; G06F 3/14; G06F 3/01

(52) U.S. Cl. CPC H04N 9/3185; G06F 3/1423; G06F 3/017; G06F 3/011; G09G 3/001; G06T 19/006; G09G 2354/00

(57) ABSTRACT

A device to manage the projection of images onto a plurality of media, and to geometrically designate and model a plurality of selected areas on display surfaces. The display areas form a visual environment of a user. The designations and models result in an environmental geometric model. A controller interprets information provided by at least one spatial interaction device of the user in the environmental geometric model. The controller generates images to be projected onto the various display areas by at least one image projector in accordance with the actions of the user as detected by the spatial interaction devices.

The present invention pertains to the domain of information presentation devices and interaction devices. It pertains more particularly to devices for projecting and displaying digital images on multiple physical surfaces taking into account the interactions of one or more users with this mainly visual environment but that can be extended to the sound domain and to any spatialized information device.

### PREAMBLE AND PRIOR ART

Computing is a universe that is perpetually evolving from various standpoints: hardware, software, architecture and uses. Computing began in the 1950s on the model of the fixed central unit (mainframe) used by several people, before evolving toward the model of personal computer in the 1980s, of computers interconnected via the Internet in the 1990s and ultimately evolving toward ubiquitous or pervasive computing where the user is surrounded by a set of computing devices with which he can interact or that he can use to monitor his environment.

These evolutions in computing hardware and its ubiquity in the environment have introduced new requirements in terms of software architecture (distributed computing), communications and exchanges of information between the various devices constituting the user's interactive environment: it is necessary to be able to manage the heterogeneity of the agents present (various aspect ratios, operating systems, etc.), to allow the user dynamic management of his tasks (to use the device or devices most suitable for his task as a function of the current context, to be able to change devices during a task, etc.) and offer the possibility of enriching the system with new devices so that the user's interactive environment is not closed.

The combination of the technical advances (calculation power, parallelism, proliferation of devices, etc.), of the methodological evolution allowing better account to be taken of user needs (user-centered design, user experience, etc.) as well as the explosion in the uses of digital in the course of recent years mean that today the production of an interactive system is ever more frequently manifested by the implementation of several computing devices, be they calculation devices, display devices, input devices, sound emission devices, etc. For example, within the framework of the production of a new functionality for navigation simulators, such as flight simulators, numerous screens represent the screens of a real aircraft cockpit, the control panels and the images seen through the window panes of the cockpit, in such a way that a user feels immersed in the environment of a real aircraft. Interaction devices such as control stick, on/off switches etc. supplement the user's environment. The images projected on the various display screens are modified in real time according to the aircraft's flight laws and according to the user's commands, such as detected through the interaction devices.

The proliferation of devices necessary for the production of these interactive environments in which the user will have access to the proposed functionalities means that these environments are generally very expensive and complex to put in place, thereby rendering the prototyping and the evaluation of new functionalities in these environments less obvious.

For the person skilled in the art, a solution to this problem of complexity of production consists in resorting to virtual reality: the users environment is reproduced virtually and the new functionalities are incorporated into this virtual environment. The user can thereafter evaluate the new functionalities by immersing himself virtually in the environment with the aid of a virtual reality headset. This approach presents several drawbacks.

On the one hand, the hardware necessary to create a really immersive virtual reality experience, that is to say in which the user is not a mere spectator but can interact with the virtual environment as he would with the real environment, is fairly prohibitive, thereby restricting its use to research and to certain business sectors where security constraints are more significant than budgetary constraints.

Moreover, even with a very immersive virtual reality experience of quality, the results obtained will not necessarily be representative of usage in the real world. The virtual world does not necessarily reproduce the real environment in all its details (sound and lighting conditions, vibrations, etc.) and it is not suitable for collaboration because virtual avatars do not make it possible to faithfully transcribe the mutual relative positions of the users and non-verbal communication (gestures, attitudes, facial mimics, etc.).

Another prior art solution relies on augmented reality, the principle of which is to mix the real world and the virtual world. The user perceives the real world through a pair of semi-transparent glasses which overlay in real time a 3D (or 2D) virtual model on his perception of the real world. With respect to virtual reality, augmented reality presents an advantage in terms of algorithm and faithfulness of rendition: the use of the real world makes it possible to place the user in a familiar environment and to reduce the modeling effort by reusing existing elements of the users environment, thereby making it possible to decrease the complexity of the graphical scene manipulated in terms of number of polygons. A major drawback of this approach is that the user must be kitted out with a pair of augmented reality glasses and this may be fatiguing for lengthy evaluations and requires equipment suitable for the sight (corrective glasses, contact lenses, etc.) of all the users participating in the evaluation, and this may be fairly expensive. Another major drawback is that each user has his own subjective view of the augmented real world, this not facilitating the creation of a shared context in situations of co-located collaboration: even if the virtual world overlaid on reality is shared, the various users do not see exactly the same thing, more particularly the virtual world presented to user may mask the hands of a second user thus preventing the first user from being fully aware of his collaborators actions.

The last solution at the disposal of the person skilled in the art is to use video-projection to enrich a real environment with virtual elements. Techniques such as “projection mapping” make it possible to project images onto structures in relief or to recreate 360° universes. Via the use of specific software, volumes are reproduced so as to obtain a video projection which is superimposed as faithfully as possible on the physical structure used for display. These techniques are particularly suitable for display on an arbitrary physical surface. To render these surfaces interactive, the person skilled in the art resorts to computer vision with 2D or 3D cameras: the approach consists in detecting by image analysis the moments at which the user touches the physical surface so as to trigger the appropriate actions to update the projected content. A drawback of this approach is that computer vision is very sensitive to occlusion: one user may mask another users actions by placing his arm or his hand between him and the camera, thus rendering him invisible to the camera. Computer vision is also sensitive to ambient light, thereby constraining the conditions of use of the environment thus produced, in particular the maximum brightness tolerated by computer vision is generally less than users' workplace lighting. Moreover, computer vision may be disturbed by the use of display devices, such as screens, within the field of the camera: light and heat emitted by these display devices may be perceived by the camera and lead to false positives. Computer vision has difficulty managing dynamic changes of the environment because this technique relies on comparing a current image with a starting condition. To take account of a change such as the appearance or the disappearance of a device in the work environment, it is necessary to dynamically recalibrate the computer vision, thereby introducing breaks in the interaction: it is necessary to wait until the system has reconfigured in order to act without risk of error on the new environment.

The present invention is aimed at remedying these drawbacks by providing a method and a device for producing rapidly and at lesser cost an interactive real environment which is able to adapt dynamically to the devices present in the said environment. More particularly, the present invention envisages a device for orchestrating display surfaces, projection devices and 2D and 3D spatial interaction devices.

The device according to the invention is particularly suitable for producing simulators, for example a cockpit simulator, but is in no way limited to this domain of use.

### DISCLOSURE OF THE INVENTION

The invention envisages firstly a device for management of display and interaction on a plurality of physical surfaces, comprising:
means for designating and geometrically modeling a plurality of areas chosen on display surfaces, and/or for projecting images, these display areas forming the visual environment of at least one user, these designations and modelings resulting in an interactive geometric environment model,
means for interpreting the information provided by at least one spatial interaction device in this geometric environment model, and
means for generating the images projected on the various display areas by at least one system for projecting and displaying images as a function of the actions of the user such as are detected by the spatial interaction devices.

The invention envisages secondly a display device, comprising a device such as set forth hereinabove and:
a plurality of passive display surfaces,
at least one system for image projection toward these display surfaces, and
at least one spatial interaction device suitable for detecting gestural instructions of a user.

The invention envisages under another aspect a method for management of display and interaction on a plurality of areas chosen on display surfaces, these display surfaces receiving images projected by at least one system for projecting images.

The method comprises a step:

100 of generating a global geometric environment model, that is to say data characterizing the position and the dimensions of each display surface facing the image projection systems, the precise orientation or precise distance of each display surface in relation to the image projection systems being unknown initially.

In a more particular implementation, the method comprises the modeling of each display surface, by using at least one of the following sub-steps:

100A direct geometric measurement in space,

100B geometric measurement with the aid of three-dimensional modeling systems,

100C visual calibration.

In a still more particular implementation, sub-step 100C comprises automated visual calibration with the aid of a computer vision system coupled to a projection system displaying various sequences of visual patterns so as to detect and calibrate the various projection planes.

In an alternative particular implementation, sub-step 100C comprises the modeling of a virtual projection plane as a function of the orientation of the system for projecting images and also of its focal length, this virtual projection plane being normal to the projection axis of the image projection system and situated at a distance dependent on the focal length of the projector.

In a particular implementation, the method comprises a step:

200 of integrating 3D spatial interaction devices into the global geometric environment model, by determining the geometric transformations necessary for interpreting the information that these 3D spatial interaction devices provide in the same three-dimensional coordinate system as that used for modeling the display surfaces.

In a more particular implementation, step 200 comprises sub-steps:

200A of calculating the coordinate transformation function between the coordinate system of the spatial interaction device and the coordinate system of the global environment model, on the basis of the coordinates of at least two points in these two coordinate systems or of one point of a vector, and

200B of generating a correspondence function for mapping between the information of the spatial interaction devices and the display surfaces.

In a particular implementation, the method comprises a step:

300 of integrating at least one 2D spatial interaction device into the global geometric environment model by determining transformation from the 2D coordinates sent by the 2D spatial interaction device into 3D coordinates that can be taken into account in the global geometric environment model.

In a particular implementation, the method comprises a step:

400 of generating the images projected on the various display surfaces in real time as a function of the actions of the user such as are detected by the spatial interaction devices, this step 400 comprising sub-steps as follows:

400A of mathematically projecting the information of the spatial interaction devices on the display surfaces, and

400B of using the spatialized information to locate physical entities and to project information on or around these entities.

It is understood that the invention then constitutes a device and a method for orchestrating display surfaces, projection devices and 2D and 3D spatial interaction devices for creating multimodal interactive environments.

Stated otherwise, the invention envisages a device and a method for unifying in one and the same three-dimensional coordinate system a plurality of display surfaces, video projection devices and input devices including at least one 2D or 3D spatial interaction device and/or a touch surface—all being able to be static or mobile—, making it possible to map any point, any line and any shape of physical space, which are produced by an input device, to one or more points and/or one or more lines and/or one or more shapes on the display surfaces and the video projection devices.

The invention relates to a system (hardware and method) suitable for recreating an environment partially or completely simulated on a set of arbitrary surfaces surrounding the user, by providing him with a display equivalent to that which he would have in a real environment, with identical tactile and/or interaction functions.

For this purpose, the software implementing the method of the invention comprises modules intended:
to adapt the geometry of an image projected by a videoprojector to one or more arbitrary surfaces not necessarily plane and not necessarily oriented facing the projector,
to project images, with the aid of the videoprojector, onto surfaces designated by the user in real time, these surfaces surrounding the user and being of arbitrary sizes and orientations, comprising or not comprising display screens,
to take account of the presence of a display screen among the designated surfaces, and to not project any image on this surface, this screen displaying directly the data to be displayed, and
to optionally manage a tactile interaction on the projection surfaces.

### PRESENTATION OF THE FIGURES

The characteristics and advantages of the invention will be better appreciated by virtue of the description which follows, which description sets forth the characteristics of the invention through a nonlimiting exemplary application.

The description is supported by the appended figures which represent:

FIG. 1: the various elements involved in an implementation of the invention, and

FIG. 2: a flowchart of the main steps of the method.

### DETAILED DESCRIPTION OF AN EMBODIMENT OF THE INVENTION

In the present mode of implementation, given here by way of nonlimiting illustration, a device according to the invention is used within the framework of the generation of a cockpit simulator. It will be referred to subsequently by the term simulation management device.

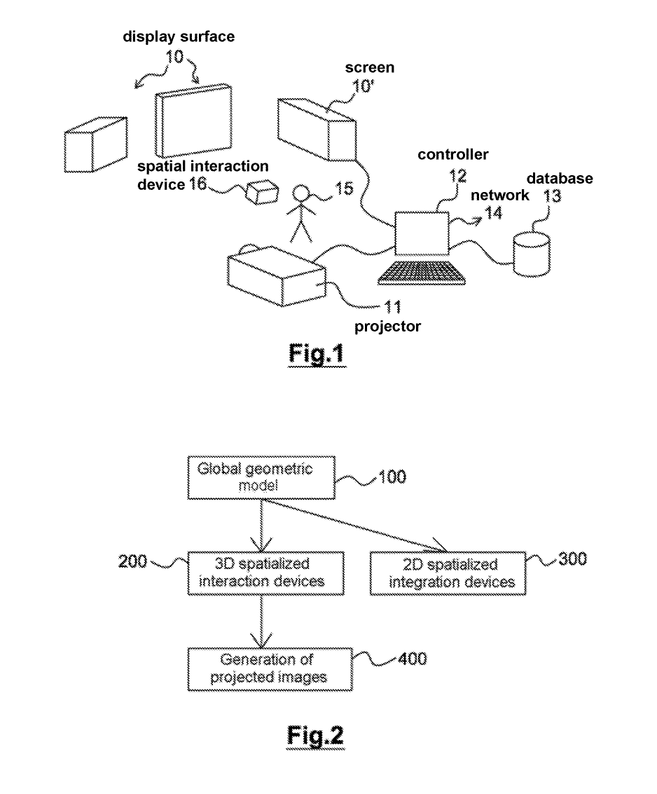

As seen in FIG. 1, the simulation management device uses for its implementation a plurality of display surfaces 10 not necessarily plane, nor necessarily parallel, connected or coplanar. The invention can naturally be implemented on a single surface, but finds its full use only for the generation of images toward several surfaces.

The display surfaces 10 considered here are in particular of passive type. That is to say that they may typically be surfaces of cardboard boxes, of boards, etc. In one embodiment given by way of simple illustrative example, the display surfaces 10 consist of a set of cardboard boxes of various sizes, disposed substantially facing a user 15 of said simulation management device.

The simulation management device comprises firstly at least one system for projecting images 11 toward these display surfaces 10, for example of videoprojector type. These systems for projecting images 11 can, more generally, consist of any device capable of generating dynamic visual information.

The simulation management device comprises secondly a controller 12, for example of microcomputer type, suitable for dispatching data to be displayed and display commands to the systems for projecting images 11. This controller 12 is linked to a database 13.

In a particular mode of implementation, certain display surfaces 10′ can consist of screens (of LCD or other type). In this case, the controller 12 dispatches the images to be displayed directly to these screens 10′.

The simulation management device comprises thirdly at least one device 16 for spatial interaction between the user 15 and the controller 12. Such a device for contactless spatial interaction may be for example of a type based on shape recognition and/or motion recognition (“Leap Motion” type, Kinect -trademark-, detection of ocular movements “Eye-tracking”, etc.). Such systems are known to the person skilled in the art, and the details of their construction lie outside the framework of the present invention. They are therefore not detailed further here, and likewise as regards the controller 12 and the systems for projecting images 11. These systems make it possible to interpret ocular or manual movements of the user as display modification commands.

It is understood that in the particular case of the implementation described here by way of example, such devices for contactless spatial interaction 16 make it possible to detect movements of the hands of the user 15 toward certain areas of the display surfaces 10, representing for example images of airplane system control panel areas. In this way, the simulation management device can modify the display as a function of the movements of the hand of the user 15, in a manner representative of what would occur if a user acted on the real control panel of the airplane system. Likewise, the simulation management device can determine, by virtue of the detectors 16, the position or the attitude of the user 15 facing the display surfaces 10, and consequently adapt the display as a function of this attitude of the user 15. This attitude can characterize either an area that he observes, or a change command destined for the vehicle forming the subject of the simulation.

In the present nonlimiting exemplary implementation, the simulation management device also comprises at least one device for interaction by contact such as a sensor, button, touch surface, etc.

The simulation management device can also comprise devices for interaction between the user 15 and the controller 12, such as voice recognition, presence detector or other active device intervening in interactive environments and generating discrete or continuous events.

In the present nonlimiting exemplary implementation, the simulation management device finally comprises a digital communication network 14 linking the elements hereinabove, and in particular the spatial interaction devices 16, the image projection systems 11 and the controller 12. The choice of the network 14 is naturally adapted to the volume of digital data (for example images) required to travel over this network.

The simulation management device finally comprises means for managing the image projection systems 11, implemented in the form of one or more software modules by the controller 12.

The method implemented by this software comprises several steps:

100. Geometric Modeling of the Visual Environment

In a step 100, a geometric modeling of the users visual environment is carried out.

The simulation management device comprises for this purpose firstly a module making it possible to combine display surfaces 10 of heterogeneous natures within one and the same numerical environment model.

These display surfaces 10 are modeled in one and the same coordinate system of this three-dimensional space (the numerical environment model). The modeling of each display surface 10 can be carried out with the aid of three inter-combinable techniques:

100A. The first modeling technique uses a direct geometric measurement in space with the aid of tools such as meters, tapes, graduated rules, etc.

100B. The second modeling technique uses a geometric measurement with the aid of three-dimensional modeling systems, for example on the basis of techniques based on accelerometer, on laser or optical processing, etc. Such techniques are known to the person skilled in the art.

These geometric measurements make it possible to model and to tag display surfaces 10 and also the image projection systems 11 which generate the images displayed by these display surfaces 10 (in particular a videoprojector in the guise of emitter device) or else the interaction devices.

100C. The third modeling technique uses visual calibration. For the person skilled in the art, the latter can be automated with the aid of a computer vision system coupled to a projection system displaying various sequences of visual patterns (chessboard, parallel bands, etc.) to detect and calibrate the various projection planes.

This visual calibration can also be manual, and carried out with the aid of graphical tools making it possible to displace virtual reference points by way of the display systems 10 so as to map them to corresponding physical reference points.

This visual calibration task may for example request the user 15 to visually place video-projected reference points on the corners of a display surface 10 forming a physical polygon, whatever the position of the image projection system 11, on condition that the latter illuminates the display surface 10 considered.

To allow genuine 3D modeling of the display surfaces 10, of the image projection systems 11 and of the interaction devices, including the distances and angles in an orthonormal coordinate system, the technique of modeling by visual calibration is combined with the first or second modeling techniques, by direct geometric measurement. Indeed, the technique of modeling by visual calibration being based only on geometric projection, it does not preserve distances. In this respect, the technique of modeling by visual calibration merely constitutes a facility for easily replacing a videoprojector 11 in the environment, provided that the display surfaces 10 onto which it projects have been modeled with one of the first two techniques 100A, 100B defined hereinabove. It should be noted that, in a particular exemplary embodiment with display on cardboard boxes acting as display surfaces 10, if the cardboard boxes are not displaced, the videoprojector 11 can be placed in an approximate manner and the visual calibration technique enables it to be “realigned” with the polygons corresponding to the display surfaces 10.

In the case where the techniques of direct geometric measurement 100A, 100B (first or second techniques for modeling the display systems 10) are used, the environment is completely modeled, in the form of a global geometric environment model, that is to say that data are available characterizing the position and the dimensions of each display surface 10 in the visual environment of the user 15 facing the image projection systems 11.

For all that, if this environment uses an image projection system 11 to feed one or more display surfaces 10, it is necessary to create a correspondence between these display surfaces 10 and the image projection system 11 in the guise of display source, in such a way that each display surface 10 is addressable on command by the image projection system 11.

In this way, the image projection system 11 can display any composite image comprising a set of images projected toward various display surfaces 10, by adapting its projection so as to make each desired image coincide with the corresponding display surface 10, whose characteristic edges or points have been identified.

The above-described technique of environment modeling by visual calibration is not the only means of geometrically modeling the visual environment. This modeling can also be ensured in the following manner:

100C′-1. Initially, a virtual projection plane is modeled as a function of the orientation of the image projection system 11 and also of its focal length. This is the plane that it would be necessary to map to a corresponding projection wall in a conventional use, for example in a meeting room. This plane is normal to the projection axis of the image projection system 11 and situated at a distance dependent on the focal length of the projector, corresponding to the image sharpness distance.

100C′-2. Subsequently, precise knowledge of the position of the “rectangle” generating this projection plane in the coordinate system of the global geometric environment model makes it possible to project onto this plane the display surfaces 10 that the image projection system 11 must feed. The result of this projection gives the coordinates, in the projection plane, of the key points for the display surfaces 10 to be fed by video projection. It is then possible to use the technique of modeling by visual calibration for these key points which have been determined by mathematical calculation rather than by the position of a physical object.

The device considered is compatible with display surfaces 10, image projection systems 11 and moving interactive devices if one knows how to dynamically update the global geometric environment model with the aid of at least one of the three environment modeling techniques defined above.

200. Management of the Spatial Interactions in Three Dimensions

In a step 200 of the method, the 3D spatial interaction devices 16 are integrated into the global geometric environment model by determining the geometric transformations necessary for interpreting the information that they provide in the same three-dimensional coordinate system as that used for modeling the visual environment.

The simulation management device comprises for this purpose secondly a module for managing the interactions provided by the spatial interaction devices 16.

200A. The calculation of the coordinate transformation function between the intrinsic coordinate system of the spatial interaction device and the coordinate system of the invention is performed by knowing the position of at least two points in these two coordinate systems or of one point of a vector.

These data necessary for the calculation can be determined with the aid of the first or second techniques for visual environment modeling, by direct geometric measurement, used for display and detailed above.

200B. In the case where the spatial interaction devices 16 considered have a behavior relating to a particular display surface 10 serving them as reference, the modeling can be supplemented with a visual calibration of these spatial interaction devices 1.

200C. The modeling of the interaction device can be obtained through the modeling of this display surface 10 in the global geometric environment model, so as to allow the calculation of the geometric transformations allowing the bijective mapping of the information generated by this spatial interaction device 16 in its reference surface, with the other display surfaces 10 and the environment as a whole. This may be the case for example for an eye tracking device capable of projecting the direction of gaze solely onto a screen. Knowing the precise coordinates of the “point of gaze” on this screen and the modeling of this screen in the global environment, it becomes simple to obtain the coordinates of the “point of gaze”, expressed in the coordinate system of the global environment.

200D. Once the calibration has been carried out, the simulation management device undertakes the calculations necessary to map the information in respect of the spatial interaction devices 16 to the corresponding display surfaces 10 and produces visual effects on them accordingly. The correspondences include in a non-exhaustive manner:
precise pointing on the display surfaces 10,
the realization of gestures of the user 15 on one or more display surfaces 10 inducing reactions or feedbacks, and
a combination of multimodal interaction (multimodal input fusion) between one of the two previous means and some other interaction device (example: voice command).

The spatialized sound sources, by using for example the solutions based on DOLBY® 5.1, a registered trademark of Dolby Laboratories Licensing Corporation, or binaural listening, can also be integrated into the coordinate system of the global environment, in just the same way as the visual devices. This demands only that the position of the user's head be known. This position can be obtained by various computer vision systems known to the person skilled in the art.

300. Management of the Spatialized Interactions in Two Dimensions

In a step 300, the method implemented in the invention, and described here in a nonlimiting example, interprets the interactions sensed by the two-dimensional spatial interaction devices (for example, a sensor which follows the ocular displacements (eye-tracking) or touch-sensitizing devices, of a precise rectangular area (tactile or multitouch framework) or of an entire plane (radarTouch, plane of light beams, laser or infrared beams), which can be used jointly with a display surface (the two then constitute a tactile or multitouch display surface) or without display surface (in this case involving devices for gestural interaction in space “in-air gesture”) and retranscribes them as modifications of display on the display surfaces 10.

Two-dimensional spatial interaction devices demand, by comparison with three-dimensional spatial interaction devices, complementary operations to transform 2D coordinates into 3D coordinates that can be taken into account in the global geometric environment model of the invention.

300A. This integration into the global geometric model entails the tying of each two-dimensional spatial interaction device to a plane reference surface (virtual or otherwise) modeled in the global environment and, thereafter, the use of ray tracing techniques to extend the capabilities of the 2D device to other display surfaces 10 of the environment.

The calibration of a 2D spatial interaction device is done with the aid of a visual calibration grid comprising a certain number of reference points, generally five or nine points even though three non-aligned points are sufficient for the person skilled in the art. These reference points can be projected onto the reference surface of the 2D spatial interaction device in various ways, using or not using the display capabilities of the invention.

In all cases, the calibration of a 2D spatial interaction device is done reference point by reference point, and makes it possible to create a correspondence between the data of the 2D spatial interaction device and the visual calibration grid.

Knowing the position of the 2D spatial interaction device in the global geometric environment model and at least one resulting point on the reference surface, the method uses ray tracing techniques, known per se, to detect intersections with other display surfaces 10 or other devices which make it possible to return to the case of a 3D spatial interaction device.

It should be noted that once the calibration has been carried out, the reference surface need no longer be visible. It is only necessary to obtain the information in respect of the resulting point or points on this reference surface from a mathematical point of view so as to be able to represent them in the coordinate system of the global environment.

400. Orchestration of the Display Surfaces 10 and of the Spatial Interaction Devices 16

In a step 400, the method implemented in the invention orchestrates the images projected onto the display surfaces as a function of the information received from all the spatial interaction devices.

The term orchestration refers to the generation of the images projected onto the various display surfaces 10 in real time as a function of the actions of the user 15 such as are detected by the spatial interaction devices 16. This modification of the images is calculated by the controller 12 and emitted to the display surfaces 10 by the image projection systems 11.

This orchestration is ensured by mathematical calculations for changing coordinate sytems and ray tracing.

400A. A first step involves mathematically projecting the information of the spatial interaction devices 16 onto the display surfaces 10. The projection obtained is used to carry out various actions on the display surfaces 10 concerned:
pointing,
triggering of actions,
equivalent of clicking or of touching by combining pointing with events coming from the gestures and movements of the user 15 on the interaction device 16 considered or coming from other sources (multimodal fusion).

The fusion of the information of the various spatial interaction devices 16 and of the display surfaces 10 within the global geometric environment model makes it possible to operate a spatial interaction device 16 on several display surfaces 10 at the same time.

400B. A second step involves using the spatialized information to locate physical entities (objects or users, example: a Leap Motion makes it possible to locate the hand of the user 15 in space) and projecting information onto or around these entities. This projection relies at one and the same time on the 3D positioning of the display surfaces 10 and on the virtual reference surfaces of the videoprojectors 11. We recall that virtual reference surface of a videoprojector 11 is intended to mean the “rectangular” surface corresponding to the area of projection of the videoprojector at its “sharpness distance”. This “rectangular” surface is normal to the projection axis of the videoprojector.

In a variant, each spatial interaction device 16 communicates the actions that it senses to the other elements (spatial interaction devices 16, display surfaces 10, image projection systems 11) of the simulation management device and each display surface 10 detects whether these actions concern it and, if appropriate, reacts by updating itself visually functionally, and by communicating with the remainder of the device.

In another variant of implementation of the device, it is possible to add, to the management software of the device, a global piloting layer which makes it possible:
to activate or to deactivate display surfaces 10 and spatial interaction devices 16 according to various conditions,
for the various display surfaces 10 and for the various spatial interaction devices 16 to mutually synchronize themselves so as to interact and react in a global and coordinated manner (techniques of multimodal input fusion known to the person skilled in the art).

In yet another variant, the simulation management device comprises at least one third-party interaction device of the voice control, presence sensors type, etc.

It can also comprise a holographic display device in addition to or in replacement for a part of the display surfaces 10.

The simulation management device described here by way of nonlimiting example finds in particular a use within the framework of the prototyping of interactive environments (cockpits, supervision systems, etc.) by making it possible to recreate and to extend all or part of a complex work environment by using prototyping devices or low-cost devices as compared with the devices which will be retained in the environment once industrialized and set into operation.

1-10. (canceled)

11. A device to manage display and interaction on a plurality of physical surfaces, comprising:
a plurality of display areas chosen on the display surfaces to project images, said plurality of display areas forming a visual environment of at least one user;
a controller to designate and geometrically model said plurality of display areas to provide a geometric environment model, to interpret information provided by at least one spatial interaction device of said at least one user in the geometric environment model, and to generate images to be projected onto said plurality of display areas; and
at least one image projector to project the generated images onto said plurality of display areas as a function of actions of said at least one user detected by said at least one spatial interaction device.

12. A display device comprising the management device according to claim 1, wherein said plurality of physical surfaces is a plurality of passive display surfaces;
wherein said at least one image projector is configured to project the generated images onto said plurality of passive display surfaces; and wherein said at least one spatial interaction device is configured to detect gestural instructions of said at least one use.

13. A method for managing display and interaction on a plurality of areas chosen on display surfaces, comprising the steps of receiving projected images by the display surfaces from at least one image projector and generating a global geometric environment model comprising data characterizing a position and dimensions of each display surface facing an image projector; and wherein an orientation or a distance of each display surface in relation to the image projector is unknown initially.

14. The method according to claim 13, further comprising a step of modeling each display surface by at least one of the following sub-steps of: a direct geometric measurement in a space, a geometric measurement with an aid of a three-dimensional modeling system, and a visual calibration.

15. The method according to claim 14, wherein the visual calibration sub-step comprises an automated visual calibration with an aid of a computer vision system coupled to the image projector displaying sequences of visual patterns to detect and calibrate projection planes.

16. The method according to claim 14, wherein the visual calibration sub-step comprises modeling a virtual projection plane as a function of an orientation and a focal length of the image projector, the virtual projection plane is normal to a projection axis of the image projector and positioned at a distance dependent on the focal length of the image projector.

17. The method according to claim 13, further comprising a step of integrating 3D spatial interaction devices into the global geometric environment model by determining geometric transformations to interpret information that the 3D spatial interaction devices provide in a same three-dimensional coordinate system as used in the global geometric environment model of the display surfaces.

18. The method according to claim 17, wherein the integrating step comprises sub-steps of:
calculating a transformation function between a coordinate system of the 3D spatial interaction devices and a coordinate system of the global geometric environment model, in accordance with positions of at least two points in the two coordinate systems or a position of one point of a vector; and
generating a correspondence function to map between information of the 3D spatial interaction devices and the display surfaces.

19. The method according to claim 13, further comprising a step of integrating at least one 2D spatial interaction device into the global geometric environment model by determining transformation from 2D coordinates received from said at least one 2D spatial interaction device into 3D coordinates of the global geometric environment model.

20. The method according to claim 13, further comprising a step of generating the projected images displayed on the display surfaces in real time as a function of actions of a user detected by spatial interaction devices.

21. The method according to claim 20, wherein the generating step comprises sub-steps of mathematically projecting spatialized information of the spatial interaction devices on the display surfaces; and utilizing the spatialized information to locate physical entities and to project information on or around the physical entities.
